(19) United States
(12) Patent Application Publication
(10) Pub. No.: US 2013/0293901 A1
(43) Pub. Date: Nov. 7, 2013

(54) METHOD FOR OPTICAL CABLE DISTANCE MEASUREMENT BY USING OPTICAL CABLE TRACKER AND OPTICAL CABLE TRACKER

(71) Applicant: Chuyuan Li, Shanghai (CN)

(72) Inventor: Chuyuan Li, Shanghai (CN)

(73) Assignees: INNO INSTRUMENT, INC., Gyeonggi-do (KR); DH INFOTECH (WEIHAI) INC., Wei Hai City (CN)

(21) Appl. No.: 13/978,627

(22) PCT Filed: Oct. 31, 2011
(86) PCT No.: PCT/CN11/01826

§ 371 Date: Jul. 8, 2013

(30) Foreign Application Priority Data
Jan. 7, 2011 (CN) 201110002455.3

(51) Int. Cl. G01B 11/02

(52) U.S. Cl. CPC G01B 11/026
USPC 356/634

(57) ABSTRACT

The invention relates to a method using an optical cable tracker to measure optical cable distances and an optical cable tracker, which comprises a light source, an optical coupler, a phase modulator, a delay optical fiber, and an optical signal demodulation module. In the invention, optical cables are knocked to create disturbance. Not only can the optical cable be identified based on the corresponding interference produced by the light ray in optical cables, but also the distances from knock points to the local telecommunication terminals can be estimated. This facilitates the inspection, repair and maintenance of optical cables.

### TECHNICAL FIELD

The invention relates to the field of optical cable distance measurements; in particular, it relates to a method of using an optical cable tracker to measure optical cable distance and an optical cable tracker.

### BACKGROUND TECHNOLOGY

In order to facilitate the maintenance, repair and other operations to optical cables, generally the optical cables between two telecommunications offices are labeled with identification tags. Namely, service personnel can obtain information comprising the sources of the optical cables based on the identification tags. However, in practice, technicians find that labels with identification are easily lost. Once the labels are lost, technicians find it difficult to confirm to which telecommunication office terminal is the optical fiber connected.

Currently, existing methods for identifying optical cables include the following:

1. Pull optical cables using physical force;

2. Detection by means of electromagnetic induction;

3. Bending middle parts of optical fibers and identifying the optical fibers based on output light intensities.

4. Cutting off optical cables.

However, Method 1 is not suitable for remotely judging optical cables. Method 2 requires the optical cables to have metal extension lines; its application scopes are limited. In Method 3, middle parts of optical fibers are bent in order to identify optical fibers by the output light intensities of optical fibers. However, it is hard to bend an optical fiber in an optical cable. Method 4 is prone to incorrect judgment and may cutoff optical cables in communication. Therefore, the aforementioned methods are to all have some defects and limitations.

Application No.: 200610111545.5 provides an optical cable identification device and an optical cable identification method. With this method, different optical cables are distinguished based on light interference generated in optical cables after disturbing the optical cables. This method readily solves the problems of optical cable identification. However, this method cannot provide rough distance estimate from a certain point on an optical cable to the local terminal. This presents much inconvenience to the service personnel.

### SUMMARY OF THE INVENTION

The first objective of the invention is to provide a method using an optical cable tracker to measure optical cable distance, thereby solving the technical problems in the existing technology that the an optical cable tracker cannot be used to measure optical cable distances.

The second objective of the invention is to provide an optical cable tracker to resolve the current failure in using optical cable trackers for optical cable distance measurements and to more conveniently assess the accident location in an optical cable.

To solve the aforementioned problems, a method of using an optical cable tracker to measure optical cable distances comprises the following steps:

(1) providing an optical cable tracker, wherein said optical cable tracker comprises a light source, at least two optical couplers, a phase modulator, a delay optical fiber, and an optical signal demodulation module. The light source, the first optical coupler, the phase modulator and the other optical coupler are sequentially connected in series. The optical signal demodulation module is connected in parallel with the optical source. The delay optical fiber is connected in parallel with the optical phase modulator;

(2) Each time the optical cable distance measurement is performed, the light source in the optical cable tracker is used to supply a beam of incident light. Then, the light output is connected with at least one optical fiber in the optical cable that is to be measured, and disturbance is created by hitting the optical cable at a test point;

(3) The incident light from the light source is split by the first optical coupler into two light beams, one passes through the phase modulator and the other passes through the delay optical fiber. Then, the two light beams are merged by the second optical coupler. The merged light beam is introduced into that optical cable that is to be measured. After the beating disturbance is received, optical phase changes in the optical fiber. A portion of the output beam is reflected back at the other end of optical cable;

(4) The reflected beam is split by the second optical coupler into two beams; one passes through the phase modulator and the other passes through the delay optical fiber. These two reflected beams are merged by the first optical coupler into an optical signal to be measured;

(5) After the optical signal to be measured is demodulated, disturbance information S₁ & S₂ are obtained;

(6) According to the disturbance information, the distance to the test point in the optical cable is obtained by calculation.

Preferably, the calculation formula used in Step (6) is as follows:

I. The first frequency multiplication coefficient S₁ and second frequency multiplication coefficient S₂ are provided by Step (5):

S₁=4E²J₁(2φₘ)sin(Δφ(t)) (1)

S₂=4E²J₂(2φₘ)cos(Δφ(t)) (2)

II. Derivation of Formula (1) and Formula (2)

S′₁=4E²J₁(2φₘ)cos(Δφ(t))Δφ′(t) (3)

S′₂=−4E²J₂(2φₘ)sin(Δφ(t))Δφ′(t) (4)

Then

S₂S′₁−S₁S′₂=16E⁴J₁(2φₘ)J₂(2φₘ)Δφ′(t) (5)

III. Integration of Formula (5)

∫S₂S′₁−S₁S′₂dt=16E⁴J₁(2φₘ)J₂(2φₘ)Δφ(t) (6)

IV. Deduce Δφ(t) and perform Fourier transformation of Δφ(t) to obtain Δφ(w). Deduce the zero frequency point fₒ in Δφ(w). Derive ZD from formula

$$f = \frac{2 k + 1}{2 {T}_{1}} = \frac{( 2 k + 1 ) c}{2 \vert ZD \vert} .$$

The result is then obtained by subtracting ZD from the total length of the optical cable.

Wherein: S₁ is the first frequency multiplication coefficient, S₂ is the second frequency multiplication coefficient, Δφ(t) is a phase difference of light beams, Δφ(w) is a power spectrum, f is a frequency, k=0, 1, 2, . . . , T₁ is the duration when light goes from the disturbance point Z to point D and then reflects back to the disturbance point Z, c is the light velocity, ZD is the distance from the point Z to point D, J₁ and J₂ respectively are the first order and second order Bessel functions, φₘ is related to the signal voltage amplitude of the optical phase modulator, and E refers to the electric field strength.

Preferably, in Step (5), the demodulation method for the optical signal that is to be measured comprises:

A1: Converting the optical signal that is to be measured into an electrical signal;

A2: Applying low-noise, high-precision amplification to the electrical signal;

A3: Adjusting the gain of the low-noise, high-precision amplified signal, and ensuring that when the input optical signal varies within preset limits, the output electrical signal remains constant;

A4: Filtering the signal after adjusting the gain;

A5: Performing phase-lock amplification of the filtered signal;

A6: Performing low-pass filtering of the phase-lock amplified signal to filter out the high-frequency components to obtain the first frequency multiplication coefficient S₁ and the second frequency multiplication coefficient S₂;

A7: Converting the processed electrical signal into a digital signal by passing it through an A/D converter module.

Preferably, the delay optical fiber shall have a length of no less than 1 km.

To solve abovementioned issues, the present invention provides an optical cable tracker for optical cable distance measurement, which comprises a light source, at least two optical couplers, a phase modulator, a delay optical fiber, and an optical signal demodulation module, wherein the light source, one of the optical couplers, the phase modulator, and another optical coupler are successively (in the order mentioned) connected in series. The optical coupler at the end is directly connected with the optical cable that is to be measured. The optical signal demodulation module is connected in parallel with the light source. The delay optical fiber is connected in parallel with the phase modulator.

Preferably, the optical signal demodulation module comprises an optical detector and preamplifier module, a main amplifier and gain module, a band-pass filter, a signal extraction module, an A/D converter module and a microprocessor, wherein these components are sequentially connected.

Preferably, the optical detector and preamplifier module consists of an optical detector and a preamplifier.

Preferably, the main amplifier and gain module consists of an amplifier and an automatic gain control module.

Preferably, the signal extraction module consists of a phase-lock amplifier and a low-pass filter amplifier.

Preferably, the microprocessor performs calculations according to the following formulae:

I. Based on the signal extraction module, the first frequency multiplication coefficient S₁ and second frequency multiplication coefficient S₂ are given as:

S₁=4E²J₁(2φₘ)sin(Δφ(t)) (1)

S₂=4E²J₂(2φₘ)cos(Δφ(t)) (2)

II. Derivation of Formula (1) and Formula (2)

S′₁=4E²J₁(2φₘ)cos(Δφ(t))Δφ′(t) (3)

S′₂=−4E²J₂(2φₘ)sin(Δφ(t))Δφ′(t) (4)

Then

S₂S′₁−S₁S′₂=16E⁴J₁(2φₘ)J₂(2φₘ)Δφ′(t) (5)

III. Integration of Formula (5)

∫S₂S′₁−S₁S′₂dt=16E⁴J₁(2φₘ)J₂(2φₘ)Δφ(t) (6)

IV. Deduce Δφ(t) and perform Fourier transformation on Δφ(t) to obtain Δφ(w). Deduce the zero frequency point fₒ in Δφ(w). Use the formula

$$f = \frac{2 k + 1}{2 {T}_{1}} = \frac{( 2 k + 1 ) c}{2 \vert ZD \vert}$$

to derive ZD. The result is obtained by subtracting ZD from the total length of the optical cable.
Wherein: S₁ is the first frequency multiplication coefficient, S₂ is the second frequency multiplication coefficient, Δφ(t) is a phase difference of light beams, Δφ(t) is a power spectrum, f is a frequency, k=0, 1, 2, 3, . . . , T₁ is the time required for the light to travel from the disturbance point Z to point D and then reflects back to the point Z, c is the light velocity, ZD is the distance from the point Z to point D, J₁ and J₂, respectively, are the first order and second order Bessel functions, is related to the signal voltage amplitude of the optical phase modulator, and E refers to the electric field strength.

Compared to the existing technology, the present invention not only can be identify cables by beating to disturb the cables, but also can measure the distance from the beating disturbance location to the local telecommunication terminal, thereby facilitating the maintenance and repair of cables.

### DESCRIPTION OF THE DRAWINGS

FIG. 1 shows a flow chart illustrating a method for the optical cable distance measurement.

FIG. 2 shows a schematic diagram of an optical signal demodulation module of an optical cable tracker for distance measurements.

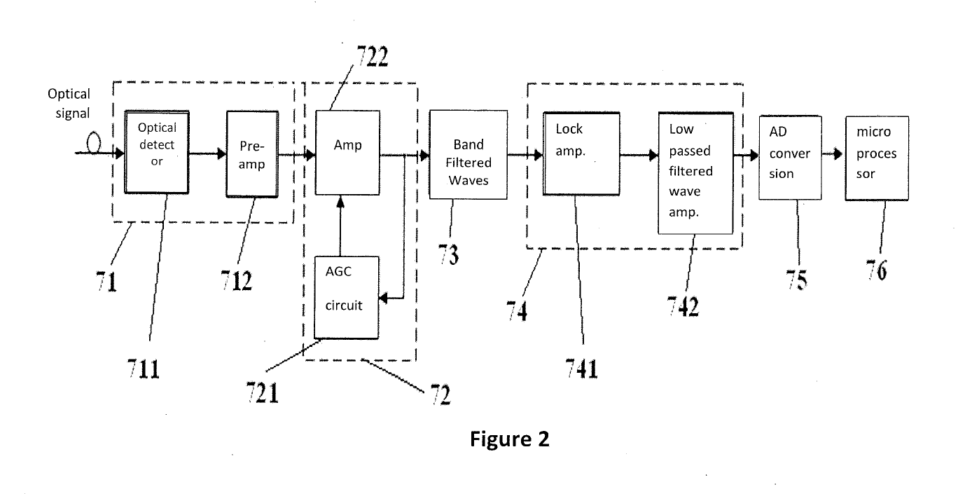

FIG. 3 shows a circuit diagram of an optical detector and preamplifier module;

FIG. 4 shows a circuit diagram of a main amplifier and gain module;

FIG. 5 shows a circuit diagram of a band-pass filter.

FIG. 6 shows a circuit diagram of a phase-locking amplifier.

### DESCRIPTION OF THE PREFERRED EMBODIMENT

Next, the invention will be further described with reference to the attached drawings.

The invention provides an optical cable tracker for optical cable distance measurements, comprising an ASE light source 1, an optical coupler 2 and an optical coupler 5, a phase modulator 3, a delay optical fiber 4 and an optical signal demodulation module 7.

The light source 1, the optical coupler 2, the phase modulator 3 and the optical coupler 5 are sequentially (in the above order) connected in series. The optical signal demodulation module 7 and the light source 1 are connected in parallel. The delay optical fiber 4 is connected in parallel with the phase modulator 3. The optical coupler 5 is directly connected with the optical cable 6 that is to be measured.

The optical signal demodulation module 7 comprises the optical detector and preamplifier module 71, main amplifier and gain module 72, band-pass filter 73, signal extraction module 74, A/D converter module 75 and microprocessor 76, wherein said components are sequentially connected (in the order mentioned). The preamplifier module 71 consists of an optical detector 711 and a preamplifier 712. The main amplifier and gain module 72 consists of an amplifier 722 and an automatic gain control module 721. The signal extraction module 74 consists of a phase-lock amplifier 741 and a low-pass filter amplifier 742.

The microprocessor performs calculations according to the following formulae:

I. Based on the signal extraction module, the first frequency multiplication coefficient S₁ and second frequency multiplication coefficient S₂ are obtained:

S₁=4E²J₁(2φₘ)sin(Δφ(t)) (1)

S₂=4E²J₂(2φₘ)cos(Δφ(t)) (2)

II. Derivation of Formula (1) and Formula (2)

S′₁=4E²J₁(2φₘ)cos(Δφ(t))Δφ′(t) (3)

S′₂=−4E²J₂(2φₘ)sin(Δφ(t))Δφ′(t) (4)

Then

S₂S′₁−S₁S′₂=16E⁴J₁(2φₘ)J₂(2φₘ)Δφ′(t) (5)

III. Integration of Formula (5)

∫S₂S′₁−S₁S′₂dt=16E⁴J₁(2φₘ)J₂(2φₘ)Δφ(t) (6)

IV. Deduce Δφ(t) and perform Fourier transformation on Δφ(t) to obtain Δφ(w). Deduce the zero frequency point fₒ in Δφ(w). Use the formula

$$f = \frac{2 k + 1}{2 {T}_{1}} = \frac{( 2 k + 1 ) c}{2 \vert ZD \vert}$$

to derive ZD. The result is obtained by subtracting ZD from the total length of the optical cable.

Wherein: S₁ is the first frequency multiplication coefficient, S₂ is the second frequency multiplication coefficient, Δφ(t) is a phase difference between light beams, Δφ(w) is a power spectrum, f is a frequency, k=0, 1, 2, . . . , T₁ is the time required for light to go from the disturbance point Z to point D and then reflects back to the point Z, c is the light velocity, ZD is the distance from the point Z to point D, J₁ and J₂, respectively, are the first order and second order Bessel functions, φₘ is related to the signal voltage amplitude of the optical phase modulator, and E refers to the electric field strength.

The optical detector 711 and preamplifier circuit 712 can directly adopt a PIN assembly and an APD assembly. The assemblies comprise a PIN photodiode and an APD (Avalanche Photo Diode) as well as a preamplifier, the output of which can be directly amplified by a main amplifier. In addition, a PIN pipe and a high-precision and low-noise operational amplifier can form a transimpedance amplifier circuit to act as a preamplifier circuit.

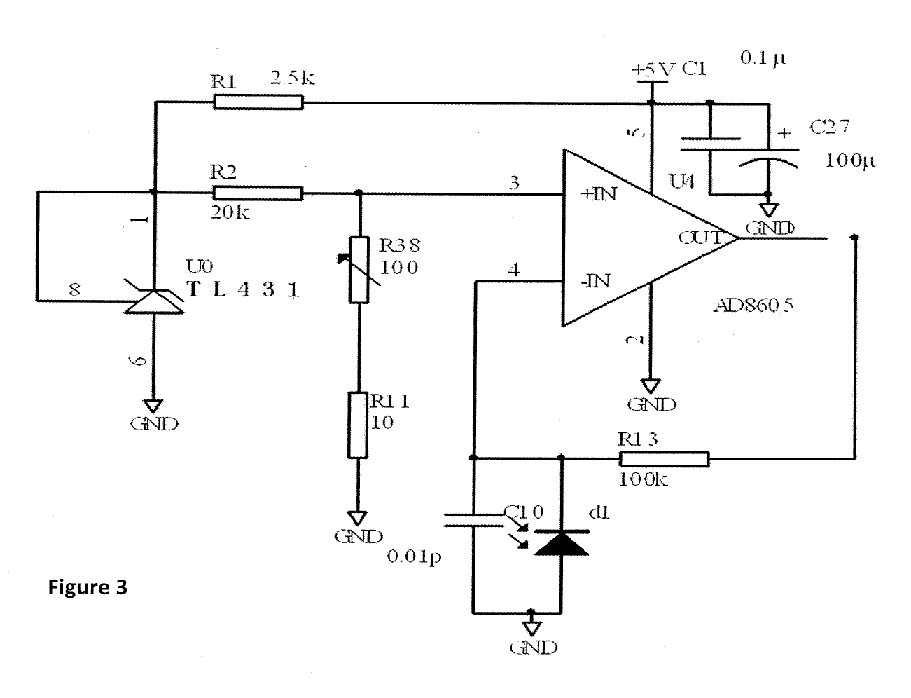

As shown in FIG. 3, a high-precision low-noise operational amplifier AD8605 is adopted in this scheme to form a transimpedance amplifier circuit acting as a preamplifier.

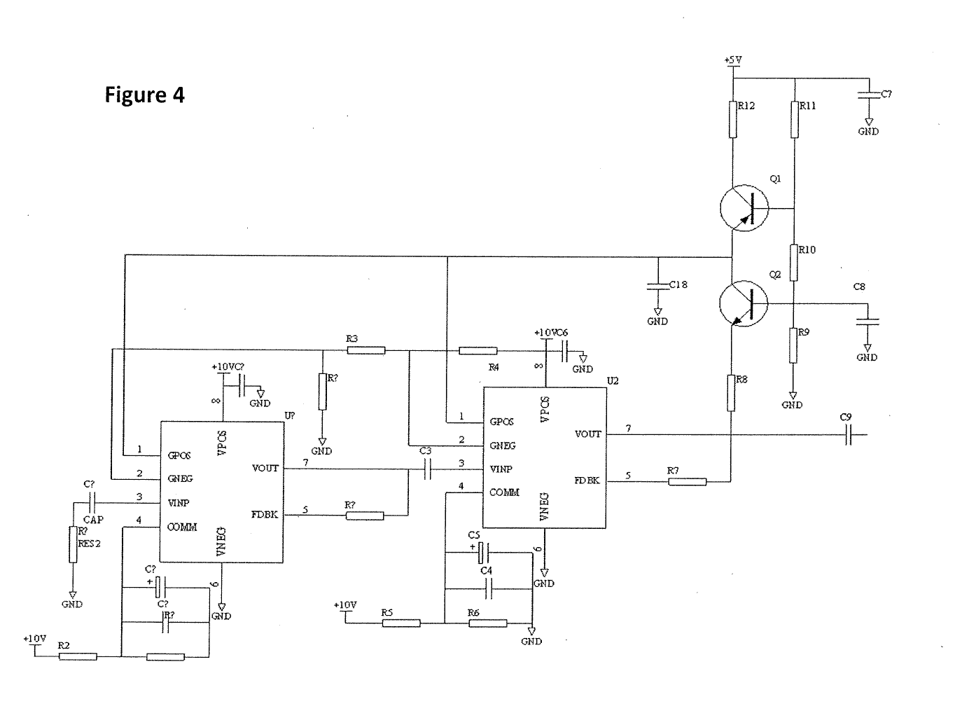

As shown in FIG. 4, a main amplifier and gain module 72 consists of a voltage-controlled gain amplifier circuit AD603, enabling two-stage cascading. The input signal is input from terminal 3 and output from terminal 7. Terminal 1 of AD603 implements the gain control, and the power source voltage is ±5V.

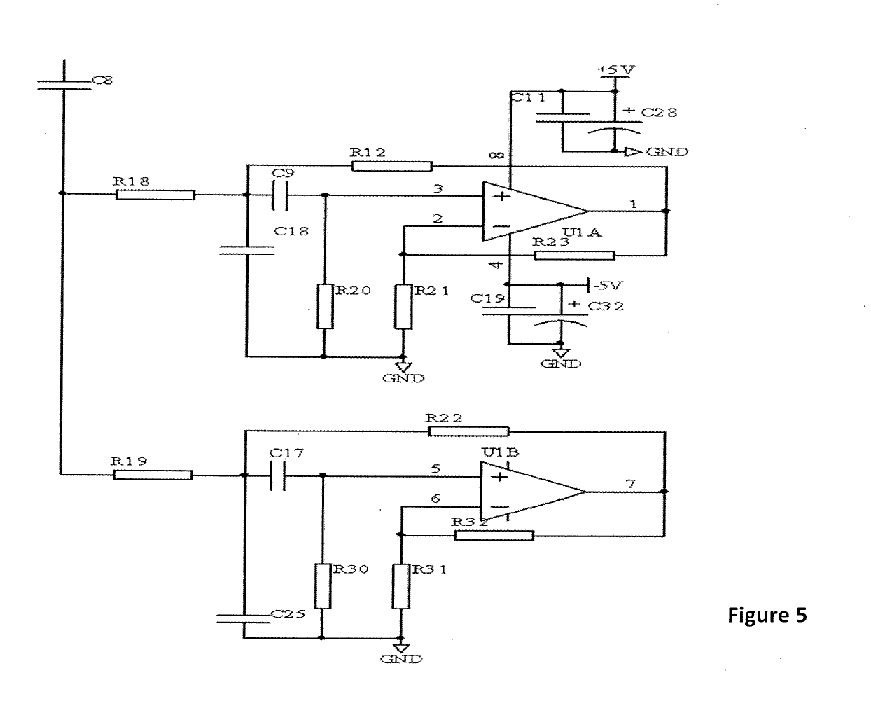

As shown in FIG. 5, a band-pass filter 73 performs preliminary signal filtration. ADA4891 makes up two voltage-controlled voltage-source-type filter circuits, the center frequencies of which are respectively the first fundamental wave and second harmonic wave, which are respectively phase-lock amplified.

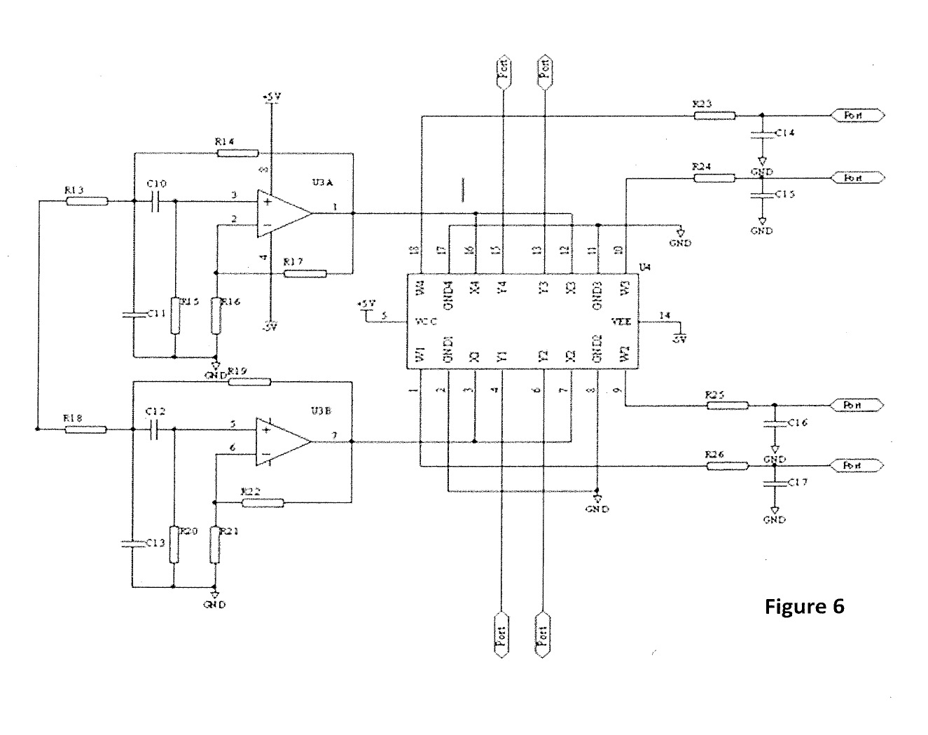

An optical signal is a weak signal against a strong-noise background, and requires the use of a phase-lock amplifier 741 to extract useful signals. As shown in FIG. 6, the phase-locking amplifier 741 consists of MLT04, which requires no external elements and requires a power supply voltage of ±5V.

Having been phase-lock amplified, the signal shall be subjected to low-pass filtering and converted by an A/D (analog-digital) converter circuit into an electrical signal to be transmitted into a microprocessor connected with the optical signal demodulation module to perform mathematical calculations. Finally, the distance from beating disturbance point to the local telecommunication terminal can be obtained.

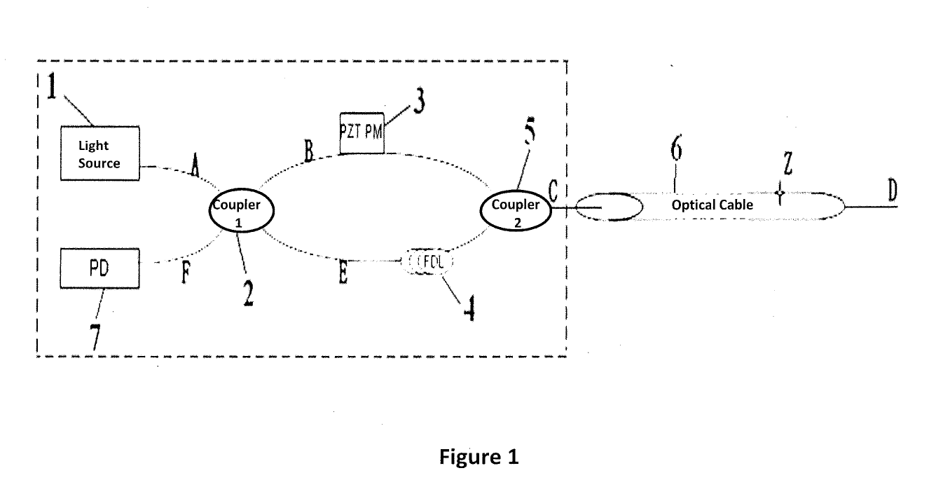

As shown in FIG. 1, the invention also relates to a method using an optical cable tracker to measure optical cable distances. A method comprises the following steps:

(1) An optical cable tracker is provided, which comprises an ASE light source 1, a first optical coupler 2 and a second optical coupler 5, a phase modulator 3, a delay optical fiber 4, and an optical signal demodulation module 7. The light source 1, the first coupler 2, the phase modulator 3 and the second coupler 5 are sequentially (in the order mentioned) connected in series. The optical signal demodulation module 7 is connected in parallel with the light source 1. The delay optical fiber 4 is connected in parallel with the optical phase modulator 3.

(2) Each time the optical cable distance measurement is performed, the ASE light source 1 in the optical cable tracker is first used to supply a beam of incident light. Then, the light output is introduced into at least one optical fiber of the optical cable 6 that is to be measured. Beating disturbance is performed at the test point Z of optical cable 6 that is to be measured;

(3) The incident light of the light source 1 is split by the first optical coupler 2 into two beams; one passes through the phase modulator 3 and the other passes through the delay optical fiber 4. These two beams are merged by the second optical coupler 5. The merged beam is introduced into the optical cable 6 that is to be measured. After beating disturbance is received, phase changes in optical fibers will occur. A portion of light output is reflected at the other end of optical cable 6;

(4) The reflected light is split by the second optical coupler 5 into two beams; one passes through the phase modulator 3 and the other passes through the delay fiber 4. These two reflected beams are merged by the first optical coupler 2 into one optical signal to be measured. At this time, the light given off from the light source 1 goes from point A and finally back to point F in four light paths: ABCZDZCEF, AECZDZCBF, ABCZDZCBF and AECZDZCEAF, respectively. There are only two light paths with equal length and will interfere with each other at point F to form the optical signal to be measured;

(5) The optical signal to be measured is demodulated to obtain disturbance information S₁ and S₂;

(6) According to the disturbance information, determine the distance of the test point of the optical cable 6 that is to be measured.

Assuming that the optical modulation phase for the phase modulator 3 is φₘ sin(ωt) and that the optical phase changes produced by the disturbance at the point Z is φ(t), then the light wave of the light path ABCZDZCEF at point F can be represented as:

Eexp{j[2πv₀t+φₘ sin(ωt)+φ(t)+φ(t+T₁)+π]}

While the light wave of the light path AECZDZCBF at point F can be represented as:

Eexp{j[2πv₀t+φ(t+τ_{D})+φ(t+τ_{D}+T₁)+φₘ sin(ω(t+T₂))+2π]}

Wherein: τ_{D} represents the time required for the light to pass through the fiber delay line (FDL), T₁ represents the time required for the light to go from the disturbance point Z to point D and then reflects back to the point Z, T₂ represents the time difference for the light in the light path ABCZDZCEF and light path AECZDZCBF to go through the PZT optical phase modulator.

As a result, the interference light intensity detected by the detector is:

$$\begin{matrix}I = 2 {E}^{2} + 2 {E}^{2} cos ( φ ( t + {τ}_{D} ) + φ ( t + {τ}_{D} + {T}_{1} ) + {φ}_{m} sin ( ω ( t + {T}_{2} ) ) - \\ φ ( t ) - φ ( t + {T}_{1} ) - {φ}_{m} sin ( ω t ) + π ) \\ = 2 {E}^{2} - 2 {E}^{2} cos ( φ ( t + {τ}_{D} ) + φ ( t + {τ}_{D} + {T}_{1} ) + {φ}_{m} sin ( ω ( t + {T}_{2} ) ) - \\ φ ( t ) - φ ( t + {T}_{1} ) - {φ}_{m} sin ( ω t ) ) \\ = 2 {E}^{2} - 2 {E}^{2} cos ( φ ( t + {τ}_{D} ) + φ ( t + {τ}_{D} + {T}_{1} ) - φ ( t ) - φ ( t + {T}_{1} ) + \\ 2 {φ}_{m} ( cos ( ω ( t + \frac{{T}_{2}}{2} ) ) sin ( \frac{{T}_{2}}{2} ω ) ) ) \\ = 2 {E}^{2} - 2 {E}^{2} cos ( Δ φ ( t ) + 2 {φ}_{m} sin ( \frac{{T}_{2}}{2} ω ) cos ( ω ( t + \frac{{T}_{2}}{2} ) ) )\end{matrix}$$

After the DC (direct current) part is filtered out, the AC (alternate current) part is:

$$2 {E}^{2} cos ( Δ φ ( t ) + 2 {φ}_{m} sin ( \frac{{T}_{2}}{2} ω ) cos ( ω ( t + \frac{{T}_{2}}{2} ) ) )$$

Select a proper modulation frequency ω such that sin(T₂/2ω) is approximately 1. Upon the transformation of sums and differences into products, the above-mentioned formula can be converted into a basic formula:

$$2 {E}^{2} cos Δ φ ( t ) cos ( 2 {φ}_{m} cos ( ω ( t + \frac{{T}_{2}}{2} ) ) ) - 2 {E}^{2} sin Δ φ ( t ) sin ( 2 {φ}_{m} cos ( ω ( t + \frac{{T}_{2}}{2} ) ) )$$

Using Bessel expansion formula:

$$cos ( x cos α ) = {J}_{0} ( x ) + 2 {\sum }_{k = 1}^{∞} {( - 1 )}^{k} {J}_{2 k} ( x ) cos 2 k α$$

$$sin ( x cos α ) = 2 {\sum }_{k = 1}^{∞} {( - 1 )}^{n + 1} {J}_{2 k - 1} ( x ) cos ( 2 k - 1 ) α$$

The basic formula can be expanded into:

$$2 {E}^{2} cos Δ φ ( t ) ( {J}_{0} ( 2 {φ}_{m} ) + 2 {\sum }_{k = 1}^{∞} {( - 1 )}^{k} {J}_{2 k} ( 2 {φ}_{m} ) cos 2 k ( ω ( t + \frac{{T}_{2}}{2} ) ) ) - 4 {E}^{2} sin Δ φ ( t ) {\sum }_{k = 1}^{∞} {( - 1 )}^{k + 1} {J}_{2 k - 1} ( 2 {φ}_{m} ) cos ( 2 k - 1 ) ( ω ( t + \frac{{T}_{2}}{2} ) )$$

Thus, the first frequency multiplication and second frequency multiplication components of ω are respectively:

$$4 {E}^{2} {J}_{1} ( 2 {φ}_{m} ) sin Δ φ ( t ) cos ( ω ( t + \frac{{T}_{2}}{2} ) ) - 4 {E}^{2} {J}_{2} ( 2 {φ}_{m} ) cos Δ φ ( t ) cos ( 2 ω ( t + \frac{{T}_{2}}{2} ) )$$

Then, select the first frequency multiplication coefficient and second frequency multiplication coefficient of ω to be respectively represented as S₁ and S₂.

Calculation formulae in Step (6) are as follows:

I. The first frequency multiplication coefficient S₁ and second frequency multiplication coefficient S₂ can be derived based on the signal extraction module.

S₁=4E²J₁(2φₘ)sin(Δφ(t)) (1)

S₂=4E²J₂(2φₘ)cos(Δφ(t)) (2)

II. Derivation of Formula (1) and Formula (2)

S′₁=4E²J₁(2φₘ)cos(Δφ(t))Δφ′(t) (3)

S′₂=−4E²J₂(2φₘ)sin(Δφ(t))Δφ′(t) (4)

Let

S₂S′₁−S₁S′₂=16E⁴J₁(2φₘ)J₂(2φₘ)Δφ′(t) (5)

III. Integration of Formula (5)

∫S₂S′₁−S₁S′₂dt=16E⁴J₁(2φₘ)J₂(2φₘ)Δφ(t) (6)

IV. Deduce Δφ(t) and perform Fourier transformation on Δφ(t) to obtain Δφ(w). Deduce the zero frequency point fₒ in Δφ(w). Use formula

$$f = \frac{2 k + 1}{2 {T}_{1}} = \frac{( 2 k + 1 ) c}{2 \vert ZD \vert}$$

to derive ZD. The result is obtained by subtracting ZD from the total length of the optical cable.

Wherein: S₁ is the first frequency multiplication coefficient, S₂ is the second frequency multiplication coefficient, Δφ(t) is a phase difference between light beams, Δφ(w) is a power spectrum, f is a frequency, k=0, 1, 2, . . . , T₁ is the time required for light to go from the disturbance point Z to point D and then reflects back to the point Z, c is the light velocity, ZD is the distance from the point Z to point D, J₁ and J₂, respectively, are the first order and second order Bessel functions, φₘ is related to the signal voltage amplitude of the optical phase modulator, and E refers to the electric field strength.

The demodulation method for the optical signal that is to be measured in Step (5) comprises:

A1: Converting the optical signal to be measured into an electrical signal;

A2: Amplifying the electrical signal with low-noise high-precision amplification;

A3: Adjusting the gain of the low-noise high-precision amplified signal, and ensuring that when the input optical signal varies within preset limits, the output electrical signal remains constant;

A4: Filtering the gain adjusted signal;

A5: Performing phase-lock amplification of the filtered signal;

A6: Performing low-pass filtration of the phase-lock amplified signal to remove the high frequency components, so as to obtain the first frequency multiplication coefficient S₁ and second frequency multiplication coefficient S₂,

A7: Converting the processed electrical signal into a digital signal using an A/D converter module.

In order to assure that subsequent calculations are accurate, the length of the delay optical fiber 4 shall not be less than 1 km.

Compared with traditional technologies, the invention not only can identify cables by beating disturbance, but also can measure the distances from the beating disturbance position to local telecommunication terminals, thereby facilitating the maintenance and repair of cables.

What is disclosed above is only one concrete embodiment of the application. However, the application is not limited to this embodiment. Any variations that can be thought about by one skilled in this field shall fall within the protection scope of the application.

What is claimed is:

1. A method of using an optical cable tracker for optical cable distance measurement, characterized in that the method comprises the following steps:
(1) providing the optical cable tracker, which comprises a light source, at least two optical couplers, a phase modulator, a delay optical fiber, and an optical signal demodulation module; said light source, a first optical coupler, said phase modulator, and a second optical coupler are sequentially connected in series; said optical signal demodulation module is connected in parallel with said light source; said delay optical fiber is connected in parallel with said phase modulator;
(2) Each time an optical cable distance is to be measured, first using said light source in said optical cable tracker to supply an incident light, which will be output and connect into at least one optical fiber of the optical cable to be measured, and beating at a test point of the optical cable to produce disturbance;
(3) splitting, using the first optical coupler, the incident light into two beams, one of the two teams passes through said phase modulator and the other passes through said delay optical fiber; then merging said two beams using the second optical coupler; introducing the merged beams into said optical cable to be measured; after receiving the beating disturbance, a phase changes in the at least optical fiber; when the beams reach the other end of the optical cable and passes through a PC connector, a portion of the beams is reflected back;
(4) splitting the reflected light, using the second optical coupler, into two light rays, one passes through said phase modulator and the other passes through said delay optical fiber; and then merging the two reflected light rays, using said first optical coupler, into an optical signal to be measured;
(5) After said optical signal to be measured is demodulated, deriving disturbance information S₁ and S₂;
(6) According to said disturbance information S₁ and S₂, calculating a distance from the test point to a local terminal of the optical cable.

2. The method of using the optical cable tracker for optical cable distance measurement as set forth in claim 1, characterized in that formulae used in the calculating in Step (6) are as follows:
I. deriving a first frequency multiplication coefficient S₁ and a second frequency multiplication coefficient S₂ in Step (5) as:
S₁=4E²J₁(2φₘ)sin(Δφ(t)) (1)
S₂=4E²J₂(2φₘ)cos(Δφ(t)) (2)
II. performing derivation on Formula (1) and Formula (2):
S′₁=4E²J₁(2φₘ)cos(Δφ(t))Δφ′(t) (3)
S′₂=−4E²J₂(2φₘ)sin(Δφ(t))Δφ′(t) (4)
Then
S₂S′₁−S₁S′₂=16E⁴J₁(2φₘ)J₂(2φₘ)Δφ′(t) (5)
III. performing integration of Formula (5):
∫S₂S′₁−S₁S′₂dt=16E⁴J₁(2φₘ)J₂(2φₘ)Δφ(t) (6)
IV. Deducing Δφ(t) and performing Fourier transformation on Δφ(t) to obtain Δφ(w); deducing a zero frequency point fₒ in Δφ(w); using the formula
$$f = \frac{2 k + 1}{2 {T}_{1}} = \frac{( 2 k + 1 ) c}{2 \vert ZD \vert} ,$$
to derive ZD; the result is obtained by subtracting ZD from a total length of the optical fiber,
wherein: S₁ is the first frequency multiplication coefficient, S₂ is the second frequency multiplication coefficient, Δφ(t) is an optical phase difference, Δφ(w) is a power spectrum, f is a frequency, k=0, 1, 2, . . . , T₁ is a duration for light to go from the point Z to point D and then reflect back to the point Z, c is light velocity, ZD is the distance from the point Z to point D, J₁ and J₂, respectively, represent the first order and second order Bessel functions, φₘ is related to a signal voltage amplitude of the optical phase modulator and E refers to the electric field intensity.

3. The method of using the optical cable tracker for optical cable distance measurement as set forth in claim 1, characterized in that the optical signal to be measured is demodulated in Step (5) by a method comprising:
A1: Converting the optical signal to be measured into an electrical signal;
A2: Amplifying the electrical signal to be measured with a low-noise, high-precision amplifier;
A3: adjusting a gain of the amplified signal from the low-noise, high-precision amplifier, and assuring that when an input optical varies within a preset limit, the output electrical signal remains constant;
A4: Filtering the gain adjusted signal;
A5: Performing phase-lock amplification of the filtered signal;
A6: Performing low-pass filtering of the phase-lock amplified signal to filter out radio-frequency components to obtain the first frequency multiplication coefficient S₁ and second frequency multiplication coefficient S₂;
A7: Converting the processed electrical signal into a digital signal by using an A/D converter module.

4. The method of using the optical cable tracker for optical cable distance measurement as set forth in claim 1, characterized in that said delay optical fiber has a length of no less than 1 km.

5. An optical cable tracker for distance measurements of an optical cable, comprising: a light source, at least two optical couplers, a phase modulator, a delay optical fiber, and an optical signal demodulation module; wherein said light source, one of the at least two optical couplers, said phase modulator, and another of the at least two optical couplers are sequentially connected in series; the optical coupler at the end is directly connected with an optical cable to be measured; said optical signal demodulation module is connected in parallel with said light source; and said delay optical fiber is connected in parallel with said phase modulator.

6. The optical cable tracker for distance measurements of an optical cable as set forth in claim 5, characterized in that said optical signal demodulation module comprises an optical detector and preamplifier module, a main amplifier and gain module, a band-pass filter, a signal extraction module, an A/D converter module, and a microprocessor, which are sequentially connected.

7. The optical cable tracker for distance measurements of an optical cable as set forth in claim 6, characterized in that said optical detector and preamplifier module consists of an optical detector and a preamplifier.

8. The optical cable tracker for distance measurements of an optical cable as set forth in claim 6, characterized in that said main amplifier and gain module consists of an amplifier and an automatic gain control module.

9. The optical cable tracker for distance measurements of an optical cable as set forth in claim 6, characterized in that the said signal extraction module consists of a phase-locking amplifier and a low-pass filter amplifier.

10. The optical cable tracker for distance measurements of an optical cable as set forth in claim 6, characterized in that the microprocessor performs calculations according to the following formulas:
I. Extracting the first frequency multiplication coefficient S₁ and the second frequency multiplication coefficient S₂ based on the signal extraction module;
S₁=4E²J₁(2φₘ)sin(Δφ(t)) (1)
S₂=4E²J₂(2φₘ)cos(Δφ(t)) (2)
II. Performing derivation of Formula (1) and Formula (2)
S′₁=4E²J₁(2φₘ)cos(Δφ(t))Δφ′(t) (3)
S′₂=−4E²J₂(2φₘ)sin(Δφ(t))Δφ′(t) (4)
Then
S₂S′₁−S₁S′₂=16E⁴J₁(2φₘ)J₂(2φₘ)Δφ′(t) (5)
III. performing integration of Formula (5)
∫S₂S′₁−S₁S′₂dt=16E⁴J₁(2φₘ)J₂(2φₘ)Δφ(t) (6)
IV. Deducing Δφ(t) and performing Fourier transformation on Δφ(w) to obtain Δφ(t); deducing a zero frequency point fₒ of Δφ(w); deducing ZD by using formula,
$$f = \frac{2 k + 1}{2 {T}_{1}} = \frac{( 2 k + 1 ) c}{2 \vert ZD \vert} ;$$
the result is obtained by subtracting ZD from a total fiber length of the optical cable;
wherein: S₁ is the first frequency multiplication coefficient, S₂ is the second frequency multiplication coefficient, Δφ(t) is an optical phase difference, Δφ(w) is a power spectrum, f is a frequency, k=0, 1, 2, . . . , T₁ is a duration for light to go from point Z to point D and then reflects back to the point Z, c^{c} is light velocity, ZD is the distance from the point Z to point D, J₁ and J₂, respectively, represent the first order and second order Bessel functions, φₘ is related to a signal voltage amplitude of the optical phase modulator and E refers to the electric field strength.
